(19) United States
(12) Patent Application Publication
(10) Pub. No.: US 2009/0165864 A1
(43) Pub. Date: Jul. 2, 2009

(54) Supersonic inlet

(75) Inventor: William Barry Bryan, Indianapolis, IN (US)

Correspondence Address: KRIEG DEVAULT LLP, ONE INDIANA SQUARE, SUITE 2800, INDIANAPOLIS, IN, 46204-2079, US

(73) Assignee: Rolls-Royce North American Technologies, Inc.

(21) Appl. No.: 12/316,898

(22) Filed: Dec. 17, 2008

Related U.S. Application Data
(60) Provisional application No. 61/009,127, filed on Dec. 26, 2007.

(51) Int. Cl. F02C 7/04

(52) U.S. Cl. 137/15.1

(57) ABSTRACT

The present invention includes a supersonic inlet having a converging portion and a diverging portion operable to diffuse engine airflow from supersonic speeds to subsonic speeds. A physical throat includes a fixed flow area at a fixed location is between the converging and diverging portions of the inlet. A fluidic injector injects pressurized fluid into the inlet to form a variable effective throat within the inlet and improve the off design efficiency of the inlet.

### CROSS REFERENCE TO RELATED APPLICATIONS

The present application claims the benefit of U.S. Provisional Patent Application 61/009,127, filed Dec. 26, 2007, and is incorporated herein by reference.

### GOVERNMENT RIGHTS

The present application was made with the United States government support under Contract No. N0014-04-D-0068, awarded by the U.S. Navy. The United States government has certain rights in the present application.

### FIELD OF THE INVENTION

The present invention relates to a supersonic inlet for a gas turbine engine, and more particularly to a supersonic inlet utilizing fluidic injection to improve off design point efficiency of the inlet.

### BACKGROUND

Supersonic aircraft are defined as aircraft that can exceed the speed of sound or Mach 1.0. Air breathing engines such as gas turbine engines are not designed to operate with an airflow velocity that is greater than Mach 1.0 as the airflow enters the compression section. Therefore the inlet to the gas turbine engine must slow the velocity of the airflow down to a predetermined level below Mach 1.0. A fixed supersonic inlet is designed for one flight condition (defined by velocity, temperature and pressure of the inlet airflow) which is sometimes called the design point. At all other flight conditions the inlet is running off design, which creates inefficiencies in the system caused by spillage drag, shock wave losses, and the like.

Some prior art supersonic inlet designs have implemented movable walls or centerbody structures and the like to improve inlet efficiency at off design conditions. However, movable structure requires large control systems, actuators, bearing systems, gears, etc., which increases system cost and carries a significant weight penalty.

Fluidics (or Fluid Logic) is the field of engineering that uses the principles of hydraulics or gas dynamics wherein a strong fluid stream is diverted by a weaker stream, with no moving solid parts. The present application discloses an apparatus and method for improving off design efficiency using fluidics in a supersonic inlet.

### BRIEF DESCRIPTION OF THE DRAWINGS

The description herein makes reference to the accompanying drawings wherein like reference numerals refer to like parts throughout the several views, and wherein:

FIG. 1 is an illustrative view of a supersonic aircraft;

FIG. 2 is a schematic view of a supersonic gas turbine engine;

FIG. 3 is a cross sectional side view of a supersonic inlet with fluidic injection according to one aspect of the present invention;

FIG. 4 is a cross-sectional front view of one embodiment of a supersonic inlet with fluidic injection; and

FIG. 5 is a cross-sectional front view of an alternate embodiment of a supersonic inlet with fluidic injection.

### SUMMARY

The present invention includes a supersonic inlet having a converging portion and a diverging portion operable to diffuse engine airflow from supersonic speeds to subsonic speeds. A physical throat having a fixed flow area and a fixed position is located between the converging and diverging portions of the inlet. A fluidic injector delivers pressurized fluid into the inlet to form a variable effective throat within the inlet and improve the off design efficiency of the inlet. Further embodiments, forms, features, aspects, benefits, and advantages shall become apparent from the description and figures provided herewith.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Supersonic aircraft fly at speeds greater than the speed of sound or Mach 1.0. An inlet for an aircraft engine or gas turbine engine receives ambient airflow and directs the airflow into a compression section of the gas turbine section. The airflow captured in the inlet has a relative velocity equivalent to the aircraft flight speed. The primary purpose of the inlet is to slow the speed of the airflow down to a design speed required by the compression section and convert the dynamic pressure into increased static pressure while minimizing flow energy losses due to shock, spillage drag and the like. This process, sometimes called ram recovery, is performed by a diffuser and the efficiency is measured by the total pressure loss that has occurred to the airflow within inlet. The total pressure of the airflow is a function of the dynamic pressure and static pressure of the airflow. Dynamic pressure is a function of the density and velocity of the airflow. If the inlet is 100% efficient the dynamic pressure will be completely converted to increased static pressure and the total pressure loss of the airflow in the inlet will be zero.

Fixed Inlets are designed to operate at peak efficiency at their design point, but will have lower efficiencies when run off design. A fixed diffuser for a supersonic gas turbine inlet is defined as a fixed passageway with an initial inlet capture annulus area that converges down to a minimum annulus area, also called the throat, and then diverges up to a larger annulus area adjacent the compression section. The gas turbine inlet of the present invention includes a fixed diffuser, but advantageously utilizes fluidic injection to create a new effective throat that can aerodynamically change the location and/or area of the inlet throat so that the fixed inlet can run at higher efficiencies at off design conditions. It should be understood that the design point of the inlet represents physical hardware designed according to a predetermined design criteria. The design criteria may or may not correspond to ideal design parameters based on aerodynamic, performance or mechanical.

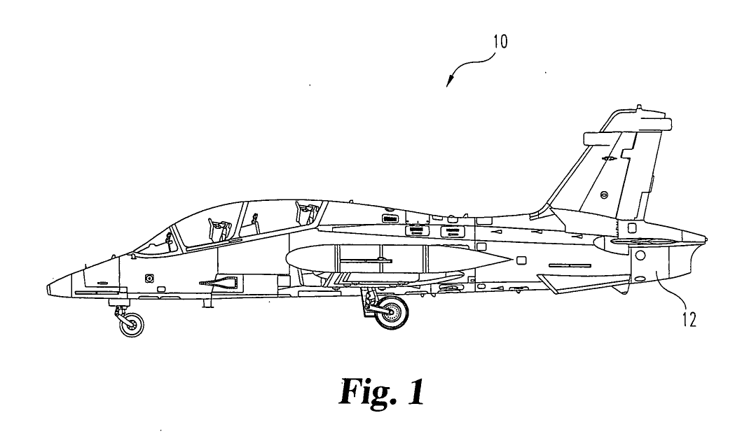

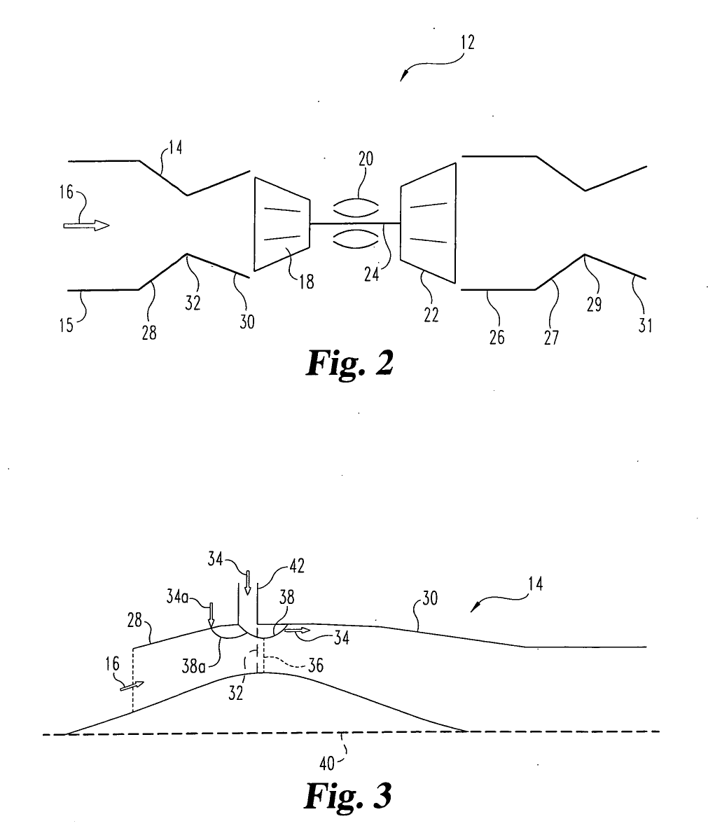

Referring to FIG. 1, a generic illustration of a supersonic aircraft 10 is shown. The aircraft 10 includes at least one gas turbine engine 12 operable for propelling the aircraft from takeoff to speeds exceeding the speed of sound or Mach 1.0. Referring to FIG. 2, a schematic view of the gas turbine engine 12 illustrates a supersonic converging-diverging inlet 14 which is operable to slow inlet airflow depicted by arrow 16 from the flight velocity to a lower velocity prior to entering a compressor section 18. The inlet 14 includes an initial capture area 15, a converging portion 28 where the annulus area is decreasing, a physical or fixed throat 32 where the annulus area is at a physical minimum, and a diverging portion 30 where the annulus area is increasing. The annulus area of any given location in a flowpath is defined as the cross-sectional width at that location rotated or extended circumferentially around a centerline of the engine 12.

When the inlet airflow 16 enters the inlet 14 at supersonic speeds the converging portion 28 acts as a diffuser to slow the velocity down while simultaneously increasing the static pressure of the airflow. A supersonic inlet operating at its design point will slow the flow velocity down to approximately Mach 1.0 at the physical throat 32. At off design conditions the airflow may reach Mach 1.0 prior to reaching the physical throat 32 or alternatively the flow velocity may not decelerate down to Mach 1.0 prior to reaching the physical throat 32. In either case, significant total pressure loss would occur in the airflow. After the airflow passes through the throat 32, the diverging portion 30 acts to further decrease the airflow velocity below Mach 1.0 and typically below Mach 0.6 depending on the design requirements of the compressor section 18.

The inlet 14 delivers airflow to the compression section 18, which may include one or more stages of fan and compressor rows. A combustor section 20 mixes fuel with the compressed air delivered by the compression section 18 and combusts the air fuel mixture at relatively constant pressure. A turbine section 22 is connected to the compression section 18 via one or more shafts 24. The turbine section 22 expands the combustion exhaust and drives the compression section 18 through the shaft 24. An exhaust nozzle 26 positioned downstream of the turbine section 22 accelerates the combustion exhaust flow to a relatively high-speed in order to produce thrust and propel the aircraft 10. The nozzle 26 includes a converging portion 27 which accelerates the flow to approximately Mach 1.0 at a throat 29. The exhaust flow is a further accelerated in a diverging section 31 of the nozzle 26 to a velocity greater than the flight velocity of the aircraft.

Referring to FIG. 3, an exemplary embodiment of a supersonic inlet 14 is schematically shown therein. The inlet 14 has a converging portion 28 and a diverging portion 30. A physical throat 32 is located between the converging and diverging portions 28, 30 respectively. The physical throat 32 is defined by the location of the minimum annulus flow area of the inlet 14.

Fluidic injection represented by arrow 34 can be used to define a new aerodynamic or effective throat 36 and thus replace the physical throat 32 as the location of the smallest annulus area. While a physical throat has a fixed throat area and a fixed location, the effective throat 36 can have a different annulus area and a different axial location than that of the physical throat 32. Furthermore the effective throat 36 can be varied during the aircraft flight to match changing airflow conditions.

The effective throat 36 is created by a variable fluidic wall 38 formed when a stream of high pressure fluid 34 is injected into the inlet 14 through a port 42. The fluid wall 38 forms an aerodynamic blockage at the point of entry and then mixes with the inlet flow 16 as each move downstream through the inlet 14. As can be seen in the drawing, the annulus area of the inlet 14 at the effective throat 36 can be smaller than the annulus area of inlet 14 at the physical throat 32. While the effective throat 36 is positioned downstream from the physical throat 32 in the exemplary embodiment, it should be understood that in practice the location of the effective throat 36 can be in the same axial location or even upstream of the physical throat 32. The effective throat 36 can be modified by changing various parameters, including but not limited to: the mass flow rate of the injected fluid 34, the velocity of the injected fluid 34, the pressure of the injected fluid 34 and the angle of incidence that the injected fluid 34 enters the main flow stream 16. It is contemplated by the present invention that the angle of incidence of fluid injection 34 into the main flow 16 can vary from being angled upstream to angled downstream, including a substantially normal entry angle.

Means for the varying the effective throat 36 can also include one or more additional fluidic injection streams such as stream 34a that can be injected at predetermined locations along a longitudinal axis 40 of the inlet 14. The additional fluidic injection stream 34a forms another variable fluidic wall 38a that can be superimposed with the variable fluidic wall 38. Alternatively, the variable fluidic wall 38a can be completely independent and non-interacting with the variable fluidic wall 38. In this manner the fluid wall 38 and/or additional fluid walls such as fluid wall 38a facilitate the generation of an alternate virtual throat that is desirable with the airflow properties in the inlet 14 at off design flight conditions.

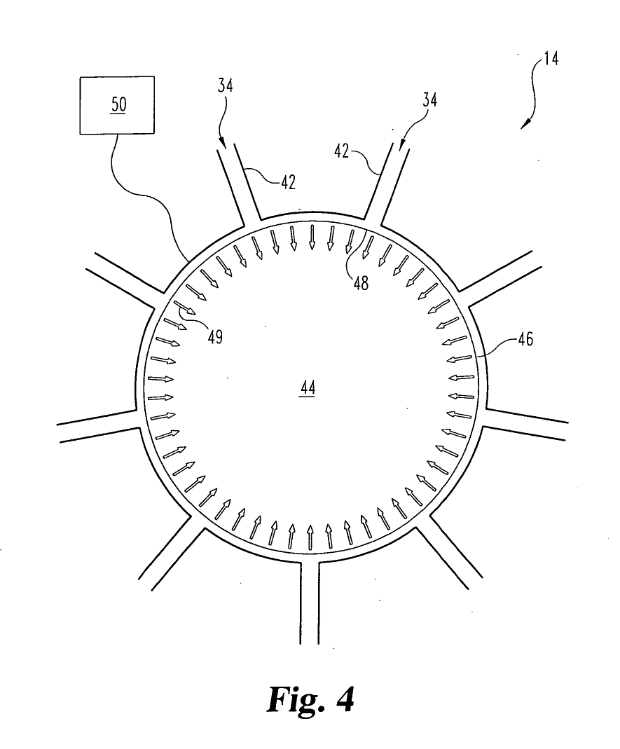

Referring now to FIG. 4, a cross-sectional view of one embodiment of an inlet 14 is illustrated. A plurality of fluidic injection ports 42 are operable to feed pressurized fluid 34 from a source (not shown) into an annulus area 44 of the inlet 14. While a plurality of injection ports 42 are shown, it should be understood that a single injection port 42 is also contemplated by the present invention. Furthermore, the injected fluid 34 can enter the annulus area 44 at several discrete points or alternatively can be fed into a manifold 46 and then delivered into the annulus area in a substantially uniform manner via one continuous 360° injection port 48 as schematically represented by arrows 49 in the figure.

In one embodiment, the fluid 34 can be supplied from the compression section 18 of the gas turbine engine 12. The pressurized fluid 34 must be extracted from a stage that has sufficient pressure to overcome the dynamic pressure of the inlet flow 16 such that a fluidic wall 38 can be formed as desired to create the effective throat 36 (see FIG. 3). In practice, this could entail bleeding flow from one or more stages of the fan or compressor as one skilled in the art will readily understand. A control system 50 may be employed to control the flow characteristics of the fluid 34 such that the pressure, velocity, and angle of incidence of the injected fluid 34 can be adequately controlled. The angle of incidence of fluid entering the inlet 14 can be controlled by various fixed nozzles positioned at various angles or variable geometry nozzles as known to those skilled in the art. The control system 50 creates a virtual wall of fluid of a desired size and shape at a desired location to define an effective throat 36. Although not shown, the control system may include a CPU, valves, actuators, signal processing, and control software to list just a few non limiting features.

An auxiliary pumping system (not shown) may be employed for pressurizing the fluid 34. The pumping system can utilize one or more pumps geared directly to the gas turbine engine or alternately driven by electric or hydraulic means. In one form the pumping system can further pressurize bleed air supplied by the compression section 18 of the gas turbine engine 12. In another form, the pumping system can pressurize ambient airflow that has not been pressurized by the compression section 18 of the gas turbine engine 12. The pump systems can include any standard pump design including positive displacement and centrifugal designs.

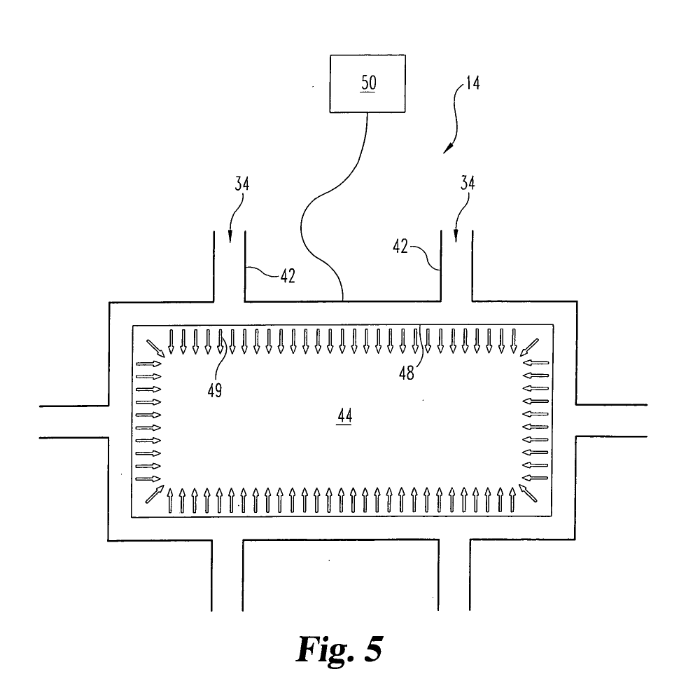

While FIG. 4 generally discloses a circular inlet 14, it should be understood that any number of cross-sectional shapes and configurations are contemplated by the present invention. For example, FIG. 5 illustrates a rectangular configuration. Other configurations can include, but are not limited to oval, square, and complex configurations having combinations of arcuate and/or linear peripheral wall segments. Similar to the round or circular configuration of FIG. 4 the alternate configurations can include intermittent discrete injection ports 34 delivering injected fluid into the inlet flow 16 or alternatively one or more ports 34 can deliver pressurized fluid to one or more 360° manifolds 48 operable for injecting a uniform stream of pressurized fluid relatively evenly around the inlet periphery.

For purposes of this application fluids are understood to be either a gas and/or a liquid. While a preferred fluid for fluidic injection is air for the present invention, other gases and liquids are also contemplated. For example liquid or gaseous fuel can be used as long as auto ignition is prevented in undesirable locations such as in the compressor. Furthermore other liquids or gases could be stored on board and utilized if it were determined to be an advantage over the use of air.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A gas turbine engine comprising:
a supersonic inlet having a converging portion and a diverging portion operable to diffuse engine airflow from supersonic speeds to subsonic speeds;
a physical throat having a fixed flow area and a fixed position between the converging and diverging portions of the inlet; and
a fluidic injector for injecting pressurized fluid into the inlet wherein an effective throat is formed within the inlet, the effective throat being different than the physical throat.

2. The gas turbine engine of claim 1, wherein the effective throat operates to aerodynamically form a desired effective flow area at a desired location.

3. The gas turbine engine of claim 1, wherein the effective throat is defined by at least one of a different location and a different flow area than that of the physical throat.

4. The gas turbine engine of claim 1, wherein the injected fluid forms an aerodynamic wall that modifies the direction of at least a portion of the engine airflow.

5. The gas turbine engine of claim 1, wherein the fluidic injector includes a plurality of injection ports.

6. The gas turbine engine of claim 5, wherein the plurality of fluidic injection ports provides a plurality of injection fluid streams to discrete locations within the inlet to modify the flow direction of the engine airflow.

7. The apparatus of claim 1, wherein the fluidic injector is positioned at a single axial location with respect to the inlet.

8. The apparatus of claim 1, wherein the fluidic injector includes a plurality of fluidic injectors positioned in a plurality of axial locations along a longitudinal axis of the inlet.

9. The gas turbine engine of claim 1, wherein the fluidic injector provides pressurized fluid to a manifold.

10. The gas turbine engine of claim 9, wherein the manifold substantially encompasses the entire inlet and disperses the pressurized fluid into the inlet as a relatively uniform flow.

11. The gas turbine engine of claim 1, wherein the inlet includes a plurality of cross sectional shapes.

12. The gas turbine engine of claim 11, wherein the plurality of annular cross sectional shapes include walls having arcuate shapes, linear shapes, and combinations thereof.

13. The gas turbine engine of claim 1, further comprising a control system for controlling the fluidic injector.

14. An apparatus comprising:
an aircraft operable at supersonic conditions;
a gas turbine engine operable to propel the aircraft at supersonic conditions;
a supersonic inlet having a physical throat and operable for delivering subsonic airflow into the gas turbine engine; and
a fluidic injector operably connected to the supersonic inlet, the fluidic injector constructed to deliver pressurized fluid into the inlet and generate an effective throat different than the physical throat.

15. The apparatus of claim 14, wherein the fluidic injector includes a continuous injection port that substantially circumscribes an entire periphery of the inlet.

16. The apparatus of claim 15, wherein the continuous port creates a substantially uniform fluidic flow distribution around the periphery of the inlet.

17. The apparatus of claim 14, wherein the effective throat has a different area than that of the physical throat.

18. The apparatus of claim 14, wherein the effective throat is positioned at a different location than the physical throat.

19. The apparatus of claim 14, wherein the effective throat is varied as a function of aircraft Mach number.

20. The apparatus of claim 14, wherein the fluidic injector is positioned in a single axial location with respect to the inlet.

21. The apparatus of claim 14, wherein the fluidic injector includes a plurality of fluidic injectors positioned in a plurality of axial locations along a longitudinal axis of the inlet.

22. A method for forming a variable supersonic inlet for a gas turbine engine comprising the steps of:
forming an inlet with a converging portion and a diverging portion;
defining a physical throat proximate an intersection of the converging and diverging portions; and
creating an effective throat in the inlet that can be modified as function of predefined airflow conditions, the effective throat operable to aerodynamically replace the physical throat.

23. The method of claim 22, wherein an effective throat is defined by variation of at least one of the annulus area and location relative to the physical throat within the inlet.

24. The method of claim 22, wherein the inlet flow conditions include at least one of Mach number, temperature, and pressure of the airflow entering the inlet.

25. The method of claim 22, wherein the creating step includes injecting pressurized fluid into the inlet flow stream.
